(19) United States
(12) Patent Application Publication
(10) Pub. No.: US 2024/0420014 A1
(43) Pub. Date: Dec. 19, 2024

(54) METHOD AND SYSTEM FOR DETERMINING ALPHA AND BETA VALUES OF A CANDIDATE RELATIVE TO A CLASS

(71) Applicant: Yahoo Assets LLC, New York, NY (US)

(72) Inventors: Eric BAX, Sierra Madre, CA (US); Max BEECH, London (GB)

(21) Appl. No.: 18/335,353

(22) Filed: Jun. 15, 2023

(51) Int. Cl. G06N 20/00; G06Q 40/06

(52) U.S. Cl. CPC G06N 20/00; G06Q 40/06

(57) ABSTRACT

Disclosed are systems and methods for determining a beta value of at least one candidate relative to a class. The method comprises receiving historical data for the at least one candidate and historical data for the class; determining a first set of regression coefficients for the historical data for the at least one candidate, and a second set of regression coefficients for the historical data for the class; and calculating the beta value for the at least one candidate relative to the class based on the first set of regression coefficients and the second sets of regression coefficients. The method may further include generating an indication that the beta value for the candidate is one of positive, negative, or zero; and transmitting to at least one display window of a graphical user interface (GUI) a graphical symbol corresponding to the indication of the beta value for the candidate.

### TECHNICAL FIELD

The present disclosure relates generally to systems and methods for determining candidates to add to a class. More particularly, and without limitation, the present disclosure relates to systems and methods for determining alpha and beta values of candidates relative to a class.

### BACKGROUND

When an investor is selecting a new investment to add to their portfolio, they may desire to be able to compare how different candidate investments would have affected the performance of their portfolio over time before making a determination about which candidate investment to add to the class of items already in their portfolio. To aid in this decision-making, many investment screening tools show investors statistics such as alpha and beta for candidate investments, which are a comparison to a particular index or to another standard investment that is not specifically related to the investor's portfolio.

Alpha is the average excess return, which is the candidate investment's return minus the return of the index or standard investment. Beta is the covariance between the candidate investment and returns of the index or standard investment, divided by the variance of returns of the index or standard investment.

These statistics give a general sense of how the candidate returns have varied over time compared to an index or other standard investment, but they do not give a good indication of how adding the candidate investment to the investor's portfolio would have affected its performance.

The following disclosure provides a solution to the aforementioned technological voids.

### SUMMARY OF THE DISCLOSURE

Embodiments of the present disclosure include systems and methods for providing alpha values and beta values of a candidate relative to a class.

In one aspect, a computer-implemented method for determining a beta value of at least one candidate relative to a class is described. The method comprises receiving, using at least one processor, historical data for the at least one candidate and historical data for the class; determining, using the at least one processor, a first set of regression coefficients for the historical data for the at least one candidate, and a second set of regression coefficients for the historical data for the class; calculating, using the at least one processor, the beta value for the at least one candidate relative to the class based on the first set of regression coefficients and the second sets of regression coefficients; generating, using the at least one processor, an indication that the beta value for the candidate is one of positive, negative, or zero; and transmitting to at least one display window of a graphical user interface (GUI) a graphical symbol corresponding to the indication of the beta value for the candidate.

In another aspect, a system for determining a beta value of at least one candidate relative to a class is described. The system comprises: at least one server; a storage device that stores instructions; and at least one processor that executes instructions the instructions to perform a method comprising: receiving, using at least one processor, historical data for the at least one candidate and historical data for the class; determining, using the at least one processor, a first set of regression coefficients for the historical data for the at least one candidate, and a second set of regression coefficients for the historical data for the class; calculating, using the at least one processor, the beta value for the at least one candidate relative to the class based on the first set of regression coefficients and the second sets of regression coefficients; generating, using the at least one processor, an indication that the beta value for the candidate is one of positive, negative, or zero; and transmitting to at least one display window of a graphical user interface (GUI) a graphical symbol corresponding to the indication of the beta value for the candidate.

In still another aspect, a non-transitory computer readable medium stores instructions for determining a beta value of at least one candidate relative to a class The instructions are configured to cause at least one processor to perform a method comprising receiving, using at least one processor, historical data for the at least one candidate and historical data for the class; determining, using the at least one processor, a first set of regression coefficients for the historical data for the at least one candidate, and a second set of regression coefficients for the historical data for the class; calculating, using the at least one processor, the beta value for the at least one candidate relative to the class based on the first set of regression coefficients and the second sets of regression coefficients; generating, using the at least one processor, an indication that the beta value for the candidate is one of positive, negative, or zero; and transmitting to at least one display window of a graphical user interface (GUI) a graphical symbol corresponding to the indication of the beta value for the candidate.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram illustrating an example of a network within which the systems and methods disclosed herein could be implemented, according to embodiments of the present disclosure.

FIG. 2 depicts a flowchart for a method for determining a beta value of at least one candidate relative to a class, according to embodiments of the present disclosure.

FIG. 3 depicts a flowchart for using a trained machine learning model to identify candidates for addition to a class, according to embodiments of the present disclosure.

FIG. 4 depicts a simplified functional block diagram of a computer and/or server that may be configured as a device or system providing specified content in an online advertising environment, according to an exemplary embodiment of the present disclosure.

### DETAILED DESCRIPTION OF EMBODIMENTS

The present disclosure describes systems and methods for determining alpha and beta values of candidate investments relative to an inventor-specific portfolio.

For investors seeking to optimize the performance of their portfolios, the ability to screen candidate investments for addition to the portfolio is of paramount consideration. To aid in this decision-making, many investment screening tools show investors statistics such as alpha and beta for candidate investments, which are a comparison to a particular index or to another standard investment as a basis, where alpha is the average excess return, which is the candidate investment's return minus the return of the index or standard investment, and beta is the covariance between the candidate investment and returns of the index or standard investment, divided by the variance of returns of the index or standard investment.

If alpha is positive, then the candidate has tended to have greater returns than the basis. If beta is near zero, then the candidate has had nearly independent returns from the basis. If beta is positive, then the basis has had a tendency to have higher returns and lower returns when the basis has. If beta is negative, then the candidate has tended to have higher returns when the basis has had lower ones, and vice versa, indicating that adding the candidate to a portfolio consisting of the basis could lower variance of returns.

These statistics give a general sense of how the candidate returns have varied over time compared to the basis, but they do not give a good indication of how adding the candidate investment to the investor's portfolio would have affected its performance. Even providing alpha and beta for the portfolio, i.e., comparing the portfolio to the basis, does not ensure a clear indication of how adding a candidate to the portfolio would have affected variance of returns. This is because it is possible, for example, for the portfolio and the candidate to both have near-zero betas, indicating near-independence from the basis, e.g., an index, and still have the candidate and portfolio have covariance of returns that is very positive, near zero, or negative with respect to each other. In other words, mutual independence from the basis does not ensure mutual independence between the candidate and the portfolio.

As such, there is need for screening statistics that are based on an investor's own portfolio, so that investors can screen candidate investments based on how adding those investments to the portfolio would have affected the portfolio's returns in terms of both expectation and variation over time.

In one exemplary embodiment, the invention is a system and methods to compute, and present to an investor, alpha- and beta-type statistics that use the investor's own portfolio as a basis, so that the investor can estimate how adding different candidate investments will affect their portfolio's expected returns and variation in returns over time. The system has price series data for a set of investments.

While principles of the present disclosure are described herein with reference to illustrative embodiments for particular applications, it should be understood that the disclosure is not limited thereto. Those having ordinary skill in the art and access to the teachings provided herein, will recognize that the features illustrated or described with respect to one embodiment, may be combined with the features of another embodiment. Therefore, additional modifications, applications, embodiments, and substitution of equivalents, all fall within the scope of the embodiments described herein. Accordingly, the invention is not to be considered as limited by the foregoing description. Various non-limiting embodiments of the present disclosure will now be described to provide an overall understanding of the principles of the structure, function, and use of systems and methods for recommending where to conduct a transaction.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine-readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure, the term “server” should be understood to refer to a service point that provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software, for example virtual servers, and one or more database systems and application software that support the services provided by the server. Cloud servers are examples.

For the purposes of this disclosure, a “network” should be understood to refer to a network that may couple devices so that communications may be exchanged, such as between a server and a personal computing device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof Likewise, sub-networks, which may employ differing architectures or may be compliant or compatible with differing protocols, may intemperate within a larger network.

For purposes of this disclosure, a “wireless network” should be understood to couple personal computing devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4th or 5th generation (2G, 3G, 4G or 5G) cellular technology, Bluetooth, 802.IIb/g/n, or the like. Network access technologies may enable wide area coverage for devices, such as personal computing devices with varying degrees of mobility, for example.

In short, a wireless network may include virtually any type of wireless communication mechanism by which signals may be communicated between devices, such as a personal computing device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a personal computing device may include a computing device capable of sending or receiving signals, such as via a wired or a wireless network. A personal computing device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A personal computing device may vary in terms of capabilities or features. Claimed subject matter is intended to cover a wide range of potential variations, such as a web-enabled personal computing device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display and components for displaying augmented reality objects, for example.

A personal computing device may include or may execute a variety of possible applications, such as a client software application enabling communication with other devices. A personal computing device may also include or execute an application to communicate content, such as, for example, textual content, multimedia content, or the like. A personal computing device may also include or execute an application to perform a variety of possible tasks, such as: browsing, searching, connecting to a network (e.g. the internet), receiving communications (e.g. phone call, emails, text messages, social media communications), streaming or displaying various forms of content, including locally stored or uploaded images and/or video, or games (such as live video calls).

For purposes of this disclosure, a machine-learning model generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

Presented below are various aspects of machine learning techniques. As will be discussed in more detail below, machine learning techniques may include one or more aspects according to this disclosure, e.g., a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

As discussed herein, a user is an individual who uses a system in accordance with the embodiments described here. However, the concept of a user is meant to be exemplary, as there may be one or more users, a user group, or a combination thereof, that access the system. Furthermore, for purposes of this disclosure, the terms “user” and “investor” are used interchangeably.

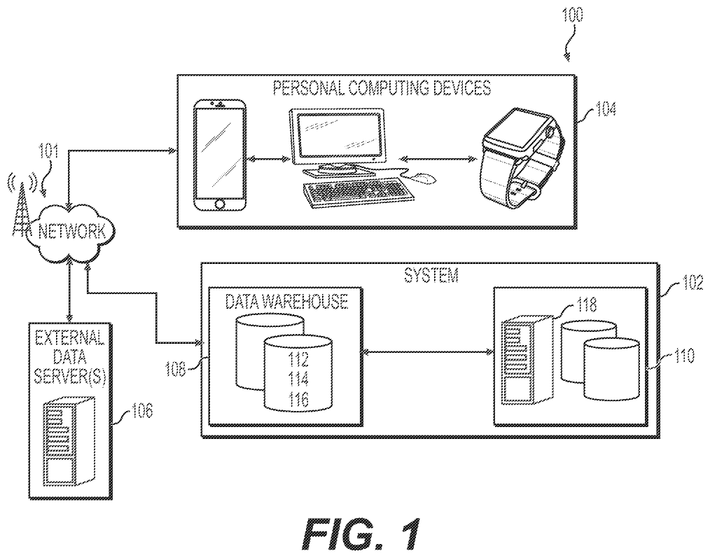

FIG. 1 depicts an example of an environment 100 within which a system 102, as disclosed herein, could be implemented. Through a network 101, the system 102 is connected to one or more user devices 104 belonging to one or more users. As an example, a user device 104 may be a smartphone, although other devices may be used, such as a personal computer, a laptop, a tablet, a smartwatch, or other devices.

The system 102 is also connected to one or more external data servers 106, which store data received from the one or more user devices 104 and from the system 102. The external data server(s) 106 may include one or more of personal computers desktop computers, multiprocessor systems, microprocessor-based or programmable consumer electronics, database(s), network PCs, server(s), and the like, maintained by third parties storing business-to-business or business-to-consumer data (e.g. Verizon®, Apple®, Google®, Netflix®, Nordstrom®, Amazon®, a government entity, or the like). The system 102 may receive data stored on the external data server(s) 106 on one or more of its computing devices. The data stored at the external data server(s) 106 may include, without limitation, information related to: investment candidates, mobile devices (e.g. iPhone®), smart accessories (e.g. Apple Watch®), artificial intelligence enabled devices (e.g. Alexa®, Google Home®, Facebook Portal®, and the like), and GPS data corresponding to a user device 104. Data relating to investment candidate(s) may include historical, current, and predicted stock prices, bond prices, and commodity prices. The data may also include data specific to a user, obtained via connection to a user device 104, including, for example, user profile(s) 112, contents of an e-mail inbox of a user, and a user web browser history within the network. The system 102 may receive or may be able to parse data from the external data server(s) 106 pertaining to specific user(s) whose user devices 104 are connected within the network 101. The system 102 may include a data warehouse 108 and an internal server 110, which may include additional data storage and one or more processors. The internal server 110 may include a portfolio optimization engine 118.

The external data servers 106 and a portfolio optimization engine 118 may communicate across an electronic network 101. The portfolio optimization engine 118 may be integrated with, or separate from (but connected to or otherwise in communication with), a GUI. The GUI may be implemented on any device capable of visual or tactile presentation of data and images in a form intelligible to a user, such as the personal computing devices 104. In some embodiments, the GUI may present information dynamically in a visual medium. In some other embodiments, the GUI may support a tactile display (display that may be felt by the fingers- and intended for the visually impaired) of data and images. In some embodiments, the GUI supporting a tactile display may further be audio-enabled, such that parameter elements are associated with one or more sounds (e.g. musical tones, filtered noises, recorded sound effects, synthesized speech, and the like), in order to further assist a visually impaired user utilizing the display. Non-limiting examples of the display on which the GUI is implemented may include a cathode ray tube, a liquid crystal display, a light emitting display, a plasma display, etc. In some embodiments, the GUI may also accept user inputs. In these embodiments, the GUI may be implemented on a device that may include a touch screen where information may be entered by selecting one of multiple options presented on the display. Selecting an option may be accomplished using a mouse (as is well known in the art), or touching an area of the display. In some embodiments, GUI may be implemented on two or more displays in communication with the portfolio optimization engine 118. As will be discussed in further detail below, a portfolio optimization engine 118 may communicate with one or more of the other components of the environment 100 across electronic network 101. The one or more external data servers 106 and/or the data warehouse 108 may be associated with a user, e.g., a user associated with one or more of generating, training, or tuning a machine-learning model for generating, obtaining, or analyzing data, and/or generating or entering investment candidates.

In some embodiments, the components of the environment 100 are associated with a common entity, e.g., a transaction processor, merchant, business enterprise, or the like. In some embodiments, one or more of the components of the environment is associated with a different entity than another. The systems, devices and databases of the environment 100 may communicate in any arrangement. As will be discussed herein, systems and/or databases of the environment 100 may communicate in order to one or more of generate, train, or use a machine-learning model to analyze data and generate actions, among other activities.

The external data servers 106 may be configured to enable the user to access and/or interact with other systems in the environment 100. For example, the external data servers 106 may be connected to a computer system such as, for example, a desktop computer, a mobile device, a tablet, etc. In some embodiments, the external data servers 106 include one or more electronic application(s), e.g., a program, plugin, browser extension, etc., installed on a memory of the computer system connected to the external data servers 106. In some embodiments, the electronic application(s) may be associated with one or more of the other components in the environment 100.

In various embodiments, the electronic network 101 may be a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the portfolio optimization engine 118 may one or more of (i) generate, store, train, or use one or more machine-learning models configured to analyze investment candidates for adding to an investor's portfolio. The portfolio optimization engine 118 may include a machine-learning model and/or instructions associated with the machine-learning model, e.g., instructions for generating a machine-learning model, training the machine-learning model, using the machine-learning model etc. The portfolio optimization engine 118 may include instructions for retrieving historical data, adjusting investment candidate parameters, e.g., based on the output of the machine-learning model, and/or operating the GUI to output investment candidate betas, e.g., as adjusted based on the machine-learning model. The portfolio optimization engine 118 may include training data, e.g., candidate investment alpha and beta, and may include ground truth, e.g., historical performance data.

In some embodiments, a system or device other than portfolio optimization engine 118 is used to generate and/or train the machine-learning model. For example, such a system may include instructions for generating the one or more machine-learning models, the training data and ground truth, and/or instructions for training the machine-learning model. A resulting trained-machine-learning model may then be provided to the portfolio optimization engine 118.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of a first machine-learning model may be configured to cause the machine-learning model to learn associations between training data that includes information regarding one or more investor's portfolios with one or more electronic databases and investment candidate data that includes alpha and beta values for one or more investment candidates in relation to the investor's portfolio as a basis, such that the trained machine-learning model is configured to determine an output to generate a new set of investment candidate recommendations.

Although depicted as separate components in FIG. 1, it should be understood that a component or a portion of a component in the environment 100 may, in some embodiments, be integrated with or incorporated into one or more other components. In another example, the portfolio optimization engine 118 may be integrated with an external data server 106. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to improve the portfolio optimization engine 118 are discussed in further detail in the methods below. In the following methods, various acts may be described as performed or executed by a component from FIG. 1, such as the portfolio optimization engine 118, the external data server(s) 106, or components thereof. However, it should be understood that in various embodiments, various components of the environment 100 discussed above may execute instructions or perform acts including the acts discussed below. An act performed by a device or system may be considered to be performed by a processor, actuator, or the like associated with that device or system. Further, it should be understood that in various embodiments, various steps may be added, omitted, and/or rearranged in any suitable manner.

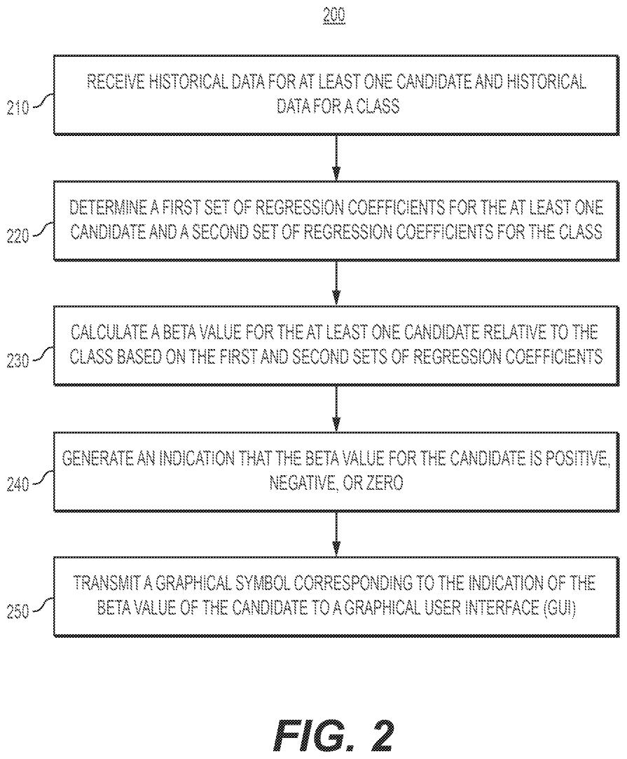

Referring to FIG. 2, a method 200 for determining a beta value of at least one candidate relative to a class is shown, according to at least some embodiments of the present disclosure. It is to be understood that the method 200 for determining a beta value of at least one candidate relative to a class shown in FIG. 2 is exemplary only and that the ordinary artisan in the relevant art will recognize that additional, fewer, or alternate steps may be followed and that any ensuing method may still be in keeping with the scope of the claims below.

At step 210, the system 102 may receive historical data for at least one candidate investment and historical data for a class, such as the investment portfolio of a user. The system 102 may include a list of candidate investments. These may be selected by an investor via a personal computing device 104 of the investor and transmitted via network 101 to the system 102, where it may be stored in a data warehouse 108 and/or transmitted to the portfolio optimization engine 118. The data warehouse 108 may include a library of investment candidates from which the portfolio optimization engine 118 filters based on, among other considerations, the investor's expressed interest, sectors of interest, or historical, present, or projected company performance statistics, such as market capitalization, price to earnings ratio, and alpha and/or beta relative to a specified index.

At step 220, a processor of the system 102 and/or a processor of the portfolio optimization engine 118 determines a first set of regression coefficients for the at least one candidate investment and a second set of regression coefficients for the class, e.g., an investor's portfolio. This would be the portfolio that the investor is considering adding the candidate investment to. The investor may also be interested in removing investments from the portfolio to make room for a candidate investment to be added to the portfolio, because the investment did not have an alpha and/or beta value in line with the investor's preferences or investment goals, or a combination of the the reasons. A third set of regression coefficients may be determined for each of the items or investments in the investor's portfolio.

The regression coefficients take the form of a series of returns for a given time period. For the portfolio, the system computes a series of returns p=(p_1, . . . , p_n) for time periods 1 to n. The time periods may be historical up to and/or including the most recent time for which a set of returns is available, may be times in the future for which returns are projected, or may be a combination of the two. Each candidate investment likewise has a series of returns r=(r_1, . . . , r_n) for time periods 1 to n computed, where the time periods 1 to n correspond to the time periods used for the portfolio. Likewise, each investment in the portfolio may have its series of returns for time periods 1 to n computed.

At step 230, the first set and second sets of regression coefficients may be used to calculate a beta value for each of the candidate investments relative to the investor's portfolio as a basis. The beta value for a given candidate is calculated as beta (r, p)=covariance (r, p)/variance (p). The beta value for each candidate investment may be positive, negative, or zero. Generally speaking, it is most likely that a candidate would be looking to add an investment candidate with a negative beta value to their portfolio, meaning that the investment candidate has a tendency to go up in value when the portfolio goes down in value, or vice versa, or is projected to do so, depending on the time periods used for the calculation. A positive beta value would indicate the investment candidate goes up and down with the portfolio, or is projected to do so, and the unlikely event of a beta value of zero indicates that the investment candidate behaves exactly as the portfolio has or is projected to.

Alpha values may also be calculated with or instead of beta values. The alpha value for a given candidate is calculated as alpha (r, p)=mean (r−p). Generally speaking, it is most likely that a candidate would be looking to add an investment candidate with a positive alpha value to their portfolio, meaning that the investment candidate has gone up in value more than the portfolio in the relevant time frame 1 to n, or is projected to go up more in the time frame. A negative alpha value would indicate the investment candidate has underperformed the portfolio, or is projected to do so, and the unlikely event of a beta value of zero indicates that the investment candidate behaves exactly as the portfolio has or is projected to. Alpha and beta values may also be calculated for each of the items in the class based on the third set of regression coefficients and the second set of regression coefficients.

The data received from the servers may be historical, it may be predicted, or both. The historical data may be adjusted for purposes of statistical inference, for example it may have Bayesian adjustments or be corrected using upper or lower confidence bounds. The system has data indicating a portfolio—a collection of investments and the amounts invested in them. The system may also have data about how the portfolio has changed over time, and it may have predictions about how the portfolio will change in the future. The portfolio data may also include trading rules, for example a rule that any investment is sold if its price becomes 20% less than its purchase price. These rules may be input by an investor, or they may be inferred from past trades by one or more investors.

One aspect of projecting future returns for calculating alpha and beta values that include projected returns is to use a Monte Carlo approach. For example, for each investment, a price series generator or a set of parameter values for a price series generator may be used. Instead of a single series of returns for the portfolio, a set P of series of returns may be computed. Similarly, for each candidate a set R of series of returns may be generated. Then the average of alpha (r, p) and beta (r, p) over a sample of p in P and r in R may be calculated and used as the estimated portfolio-based alpha and beta for the candidate investment.

At step 240, the method may include generating an indication that the beta value for the investment candidate is positive, zero, or negative. The method may also include generating an indication of the alpha value for the investment candidate, and/or indications of the alpha and beta values for a plurality of investment candidates simultaneously. These values may be stored in a database for access by the user via a GUI, for access by a machine learning model, or for any other access and use. The values may be stored in a matrix or table. The matrix may comprise each of the candidate investments and their respective beta values and/or their respective alpha values. Separate matrices may be provided for beta values and alpha values. The matrices may further include the investments already in the investor's portfolio and their respective alpha and/or beta values, and information pertaining to the portfolio as a whole and to factors not included in the portfolio, such as the performance of other indices and the market generally.

At step 250, the method may further include generating and displaying the indication on the GUI of a user device 104, and may include using different tags or color codes for different values. For example, a negative beta value may be displayed in green while a positive beta value is displayed in red. Furthermore, a beta value with an absolute value that is smaller than a predetermined threshold value may be displayed with a different tag as well, such as bolding those beta values. Similar optionality may be available for alpha values. The method may also include optionality for ranking and filtering investment candidates from the plurality of candidates based on their alpha and beta values. For example, a user may be able to input a request that only investment candidates within a specified range of alpha values, beta values, or alpha and beta values be displayed. Alternatively, the method may include automatically filtering or ranking investment candidates based on user preferences that may be input by the user or inferred through a machine learning model based on previous trades and actions by the user. There may also be provided user functionality with the databases via the display window of the GUI, such as options to filter and rank investment candidates, options to visualize changes to the portfolio based on addition of investment candidates or removal of items already in the portfolio, and other information accessible to the investor.

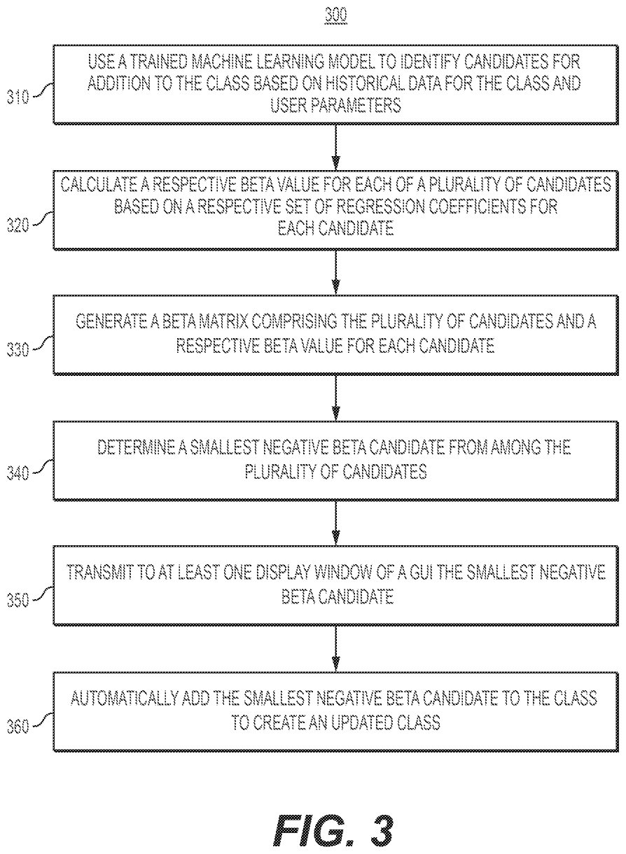

Referring now to FIG. 3, a flowchart depicting a method 300 for using a trained machine-learning model to identify investment candidates for addition to a class, such as investor's portfolio will be shown, according to at least some embodiments of the present disclosure. It is to be understood that the method 300 for using a trained machine learning model to identify investment candidates for addition to a class shown in FIG. 3 is exemplary only and that the ordinary artisan in the relevant art will recognize that additional, fewer, or alternate steps may be followed and that any ensuing method may still be in keeping with the scope of the claims below.

At step 310, the method may include using a trained machine learning model, such as portfolio optimization engine 118, to identify candidates, such as investment candidates, for addition to a class, such as a user or an investor's investment portfolio, based on data for the class, data for potential candidates, and user parameters. The data for the class and the potential candidates may include historical data and projected data, the historical data including returns for the class, or portfolio, and for the potential candidates, and information about the candidates such as type of industry, market capitalization, country of origin, etc. The user parameters may be user's preferences input by the user or inferred by the user's activities by the machine learning model, such as previous trades made by the user, or the types of investments held in the user's portfolio. The user parameters may include but are not limited to: investment type, investment sector, volatility, market capitalization, investment region, investment target, investment timeline, and frequency of trading. The portfolio optimization engine 118 receives as inputs and training data the user's inputs to these parameters either directly or by inferring values for these and other parameters by being trained on the user's past activities.

At step 320, the first set and second sets of regression coefficients may be used to calculate a beta value for each of the candidate investments relative to the investor's portfolio as a basis. Just as in the method described in FIG. 2, the beta value for a given candidate is calculated as beta (r, p)=covariance (r, p)/variance (p). The beta value for each candidate investment may be positive, negative, or zero. Generally speaking, it is most likely that a candidate would be looking to add an investment candidate with a negative beta value to their portfolio, meaning that the investment candidate has a tendency to go up in value when the portfolio goes down in value, or vice versa, or is projected to do so, depending on the time periods used for the calculation. A positive beta value would indicate the investment candidate goes up and down with the portfolio, or is projected to do so, and the unlikely event of a beta value of zero indicates that the investment candidate behaves exactly as the portfolio has or is projected to.

Alpha values may also be calculated with or instead of beta values. The alpha value for a given candidate is calculated as alpha (r, p)=mean (r-p). Generally speaking, it is most likely that a candidate would be looking to add an investment candidate with a positive alpha value to their portfolio, meaning that the investment candidate has gone up in value more than the portfolio in the relevant time frame 1 to n, or is projected to go up more in the time frame. A negative alpha value would indicate the investment candidate has underperformed the portfolio, or is projected to do so, and the unlikely event of a beta value of zero indicates that the investment candidate behaves exactly as the portfolio has or is projected to.

Optionally, at step 330, the method 300 may include generating a table of alpha and/or beta values for each of the plurality of candidate investments. The table can take the form of a matrix that may include alpha values, beta values, and other information on each of the investment candidates, such as projected values, market capitalizations, and other information generally relevant to investors. The matrix may be made viewable to the user, by generating a display on a GUI of a user device, and/or it may be stored in a database to be accessed by the machine learning model to train the model and to use the model to determine a best candidate or best candidates for addition to the class. Determining a best candidate may be done by the machine learning model based on a variety of factors, including alpha values, beta values, and other information about the candidates as it relates to the investor's portfolio.

In an exemplary embodiment, a best candidate may be determined at step 340 by determining a smallest negative beta candidate from the plurality of candidates. A smallest negative beta candidate is defined as the candidate investment with a beta value that is negative and having an absolute value that is smaller than the absolute value of all other candidate investments with a negative beta value. For example, a set of candidate investments may have the following beta values when using a user's investment portfolio as a basis: candidate A: 1.0; candidate B:−0.3; candidate C: 0.5; candidate D:−0.2; candidate E:−1.0. The model filters candidates B, D, and E, the candidates with negative beta values for further analysis and, in this simple example, determines that candidate D with a beta value of −0.2 is the smallest negative beta candidate from among the plurality of candidates, determining it to be the best candidate as defined by this model.

The model may use other parameters for determining a best candidate among the plurality of candidates, such as a greatest negative beta value. In this scenario, candidate E with a beta value of −1.0 would be identified as a best candidate. User preferences may also be inferred or included as parameters. For example, if the investor indicates by preference or by past actions a reluctance to invest in the energy sector or an affinity for investment in emerging markets, the model may determine candidates that better fit the investor's preferences. In such an example, the model may determine that, though candidate D has a smaller beta value (−0.2) than candidate B (−0.3), the investor may prefer candidate B to candidate D because candidate B is the stock of a technology company based overseas, while candidate D is a domestic energy company. In addition to beta values, alpha values may also be used in conjunction with and/or in place of beta values to determine best candidates for investment.

At step 350, the method may include transmitting to at least one display window of a GUI of a user device the smallest negative beta candidate, or the best candidate or candidates determined by any other method, to communicate to the investor the output of the trained machine learning model. Optionally, at step 360, the method may further include automatically executing trades on behalf of the investor to automatically add the best candidate to the class, or portfolio, to create an updated class that includes the best candidate. This step may include eliciting information from the investor about which investments and amounts in their portfolios they are considering selling to buy a new investment. This step may also include determining a highest positive beta item, or investment, from the items in the class, i.e., the investments already in the portfolio. The method may include transmitting this information to the GUI and showing both the smallest negative beta investment candidates and highest positive beta investments already in the portfolio, and optionally automatically replacing the highest beta item from the class with the smallest negative beta candidate to create an updated class.

This functionality may be expanded to multiple candidate investments and multiple investment items in the class, or portfolio. For example, the two smallest negative beta candidates may automatically be added and the two highest beta items may be removed, or the smallest negative beta candidate may be added and the two highest beta items may be removed, or any combination thereof. A prompt may be transmitted to a display window of the GUI of a user device prompting the user to approve such an addition or removal, or it may be done automatically.

Additionally, the alpha and beta numbers for candidates may be based on the composition of the portfolio after the sale. In some embodiments, instead of a fixed portfolio, the method may use the investor's portfolio as it has evolved over time as the basis for determining the alpha and beta values for each candidate before executing this step of the method.

In yet other embodiments, instead of the candidate investment, the alpha and beta values may be calculated for a modified investment, such as the candidate investment and a specified amount of cash starting from a specified time. The amounts of the investment and cash may be adjusted over time to reflect selling the investment or buying more of it according to some business rules inferred from the user's previous activities or specified by the user. For example, the rule may be: sell the investment if its value drops by more than 20% since it was bought, or buy it back if its value increases by at least 5% since it was sold.

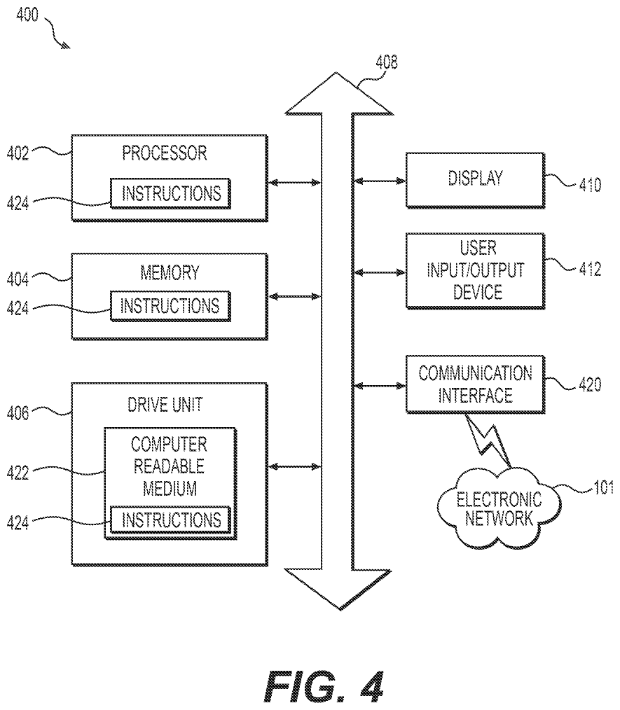

FIG. 4 depicts an implementation of a controller 400 that may execute techniques presented herein, according to one or more embodiments. The controller 400 may include a set of instructions that can be executed to cause the controller 400 to perform any one or more of the methods or computer based functions disclosed herein. The controller 400 may operate as a standalone device or may be connected, e.g., using a network, to other computer systems or peripheral devices.

In a networked deployment, the controller 400 may operate in the capacity of a server or as a client in a server-client user network environment, or as a peer computer system in a peer-to-peer (or distributed) network environment. The controller 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 400 can be implemented using electronic devices that provide voice, video, or data communication. Further, while the controller 400 is illustrated as a single system, the term “system” shall also be taken to include any collection of systems or sub-systems that individually or jointly execute a set, or multiple sets, of instructions to perform one or more computer functions.

As illustrated in FIG. 4, the controller 400 may include a processor 402, e.g., a central processing unit (CPU), a graphics processing unit (GPU), or both. The processor 402 may be a component in a variety of systems. For example, the processor 402 may be part of a standard computer. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The controller 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the controller 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the controller 400 may include an input device 412 configured to allow a user to interact with any of the components of controller 400. The input device 412 may be a number pad, a keyboard, or a cursor control device, such as a mouse, or a joystick, touch screen display, remote control, or any other device operative to interact with the controller 400.

The controller 400 may also or alternatively include drive unit 406 implemented as a disk or optical drive. The drive unit 406 may include a computer-readable medium 422 in which one or more sets of instructions 424, e.g. software, can be embedded. Further, the instructions 424 may embody one or more of the methods or logic as described herein. The instructions 424 may reside completely or partially within the memory 404 and/or within the processor 402 during execution by the controller 400. The memory 404 and the processor 402 also may include computer-readable media as discussed above.

In some systems, a computer-readable medium 422 includes instructions 424 or receives and executes instructions 424 responsive to a propagated signal so that a device connected to a network 470 can communicate voice, video, audio, images, or any other data over the network 470. Further, the instructions 424 may be transmitted or received over the network 470 via a communication port or interface 420, and/or using a bus 408. The communication port or interface 420 may be a part of the processor 402 or may be a separate component. The communication port or interface 420 may be created in software or may be a physical connection in hardware. The communication port or interface 420 may be configured to connect with a network 470, external media, the display 410, or any other components in controller 400, or combinations thereof. The connection with the network 470 may be a physical connection, such as a wired Ethernet connection or may be established wirelessly as discussed below. Likewise, the additional connections with other components of the controller 400 may be physical connections or may be established wirelessly. The network 470 may alternatively be directly connected to a bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The controller 400 may be connected to a network 470. The network 470 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 470 may include wide area networks (WAN), such as the Internet, local area networks (LAN), campus area networks, metropolitan area networks, a direct connection such as through a Universal Serial Bus (USB) port, or any other networks that may allow for data communication. The network 470 may be configured to couple one computing device to another computing device to enable communication of data between the devices. The network 470 may generally be enabled to employ any form of machine-readable media for communicating information from one device to another. The network 470 may include communication methods by which information may travel between computing devices. The network 470 may be divided into sub-networks. The sub-networks may allow access to all of the other components connected thereto or the sub-networks may restrict access between the components. The network 470 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel processing. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for determining a beta value of at least one candidate relative to a class, the method comprising:
receiving, using at least one processor, historical data for the at least one candidate and historical data for the class;
determining, using the at least one processor, a first set of regression coefficients for the historical data for the at least one candidate, and a second set of regression coefficients for the historical data for the class;
calculating, using the at least one processor, the beta value for the at least one candidate relative to the class based on the first set of regression coefficients and the second sets of regression coefficients;
generating, using the at least one processor, an indication that the beta value for the candidate is one of positive, negative, or zero; and
transmitting to at least one display window of a graphical user interface (GUI) a graphical symbol corresponding to the indication of the beta value for the candidate.

2. The method of claim 1, further comprising:
using a trained machine learning model to select the at least one candidate based on the historical data for the class.

3. The method of claim 2, wherein the machine learning model is trained on the historical data for the class and a set of parameters provided by a user.

4. The method of claim 1, wherein the at least one candidate comprises a plurality of candidates, each candidate of the plurality of candidates including a respective set of regression coefficients; the method further comprising:
calculating, using the at least one processor, a respective beta value for each candidate of the plurality of candidates;
generating, using the at least one processor, a beta matrix comprising the plurality of candidates and the respective beta values for each of the plurality of candidates;
storing, using the at least one processor, the beta matrix in a beta database; and
providing user interaction functionality with the beta database via the display window of the GUI.

5. The method of claim 4, further comprising:
determining, by the at least one processor, a smallest negative beta candidate from among the plurality of candidates;
transmitting to the at least one display window the smallest negative beta candidate; and
automatically adding the smallest negative beta candidate to the class to create an updated class.

6. The method of claim 1, wherein the class is comprised of a plurality of items, the method further comprising:
receiving, using the at least one processor, historical data for each of the plurality of items;
determining, using the at least one processor, a third set of regression coefficients for the historical data for each of the plurality of items;
calculating, using the at least one processor, a beta value for each of the items relative to the class based on the third set of regression coefficients and the second sets of regression coefficients; and
transmitting to the at least one display window the beta value for each of the items.

7. The method of claim 1, wherein the at least one candidate comprises a plurality of candidates, each candidate of the plurality of candidates including a respective set of regression coefficients and the class is comprised of a plurality of items; the method further comprising:
calculating, using the at least one processor, a respective beta value for each candidate of the plurality of candidates;
determining, by the at least one processor, a smallest negative beta candidate from among the plurality of candidates;
receiving, using the at least one processor, historical data for each of the plurality of items;
determining, using the at least one processor, a third set of regression coefficients for the historical data for each of the plurality of items;
calculating, using the at least one processor, a beta value for each of the items relative to the class based on the third set of regression coefficients and the second sets of regression coefficients;
determining, by the at least one processor, a highest positive beta item from among the plurality of items; and
transmitting to the at least one display window the smallest beta candidate and the highest positive beta item and/or automatically adding the smallest negative beta candidate to the class and removing the highest positive beta item from the class to create an updated class.

8. The method of claim 7, further comprising:
generating, using the at least one processor, a beta matrix comprising the plurality of candidates and the respective beta values for each of the plurality of candidates, and the plurality of items and the respective beta values for each of the plurality of items;
storing, using the at least one processor, the beta matrix in a beta database; and
providing user interaction functionality with the beta database via the display window of the GUI.

9. A system for determining a beta value of at least one candidate relative to a class, the system comprising:
at least one server;
a storage device that stores instructions; and
at least one processor that executes instructions the instructions to perform a method comprising:
receiving, using at least one processor, historical data for the at least one candidate and historical data for the class;
determining, using the at least one processor, a first set of regression coefficients for the historical data for the at least one candidate, and a second set of regression coefficients for the historical data for the class;
calculating, using the at least one processor, the beta value for the at least one candidate relative to the class based on the first set of regression coefficients and the second sets of regression coefficients;
generating, using the at least one processor, an indication that the beta value for the candidate is one of positive, negative, or zero; and
transmitting to at least one display window of a graphical user interface (GUI) a graphical symbol corresponding to the indication of the beta value for the candidate.

10. The system of claim 9, further comprising:
using a trained machine learning model to select the at least one candidate based on the historical data for the class.

11. The system of claim 10, wherein the machine learning model is trained on the historical data for the class and a set of parameters provided by a user.

12. The system of claim 9, wherein the at least one candidate comprises a plurality of candidates, each candidate of the plurality of candidates including a respective set of regression coefficients; the method further comprising:
calculating, using the at least one processor, a respective beta value for each candidate of the plurality of candidates;
generating, using the at least one processor, a beta matrix comprising the plurality of candidates and the respective beta values for each of the plurality of candidates;
storing, using the at least one processor, the beta matrix in a beta database; and
providing user interaction functionality with the beta database via the display window of the GUI.

13. The system of claim 12, further comprising:
determining, by the at least one processor, a smallest negative beta candidate from among the plurality of candidates;
transmitting to the at least one display window the smallest negative beta candidate; and
automatically adding the smallest negative beta candidate to the class to create an updated class.

14. The system of claim 9, wherein the class is comprised of a plurality of items, the method further comprising:
receiving, using the at least one processor, historical data for each of the plurality of items;
determining, using the at least one processor, a third set of regression coefficients for the historical data for each of the plurality of items;
calculating, using the at least one processor, a beta value for each of the items relative to the class based on the third set of regression coefficients and the second sets of regression coefficients; and
transmitting to the at least one display window the beta value for each of the items.

15. The system of claim 9, wherein the at least one candidate comprises a plurality of candidates, each candidate of the plurality of candidates including a respective set of regression coefficients and the class is comprised of a plurality of items; the method further comprising:
calculating, using the at least one processor, a respective beta value for each candidate of the plurality of candidates;
determining, by the at least one processor, a smallest negative beta candidate from among the plurality of candidates;
receiving, using the at least one processor, historical data for each of the plurality of items;
determining, using the at least one processor, a third set of regression coefficients for the historical data for each of the plurality of items;
calculating, using the at least one processor, a beta value for each of the items relative to the class based on the third set of regression coefficients and the second sets of regression coefficients;
determining, by the at least one processor, a highest positive beta item from among the plurality of items; and
transmitting to the at least one display window the smallest beta candidate and the highest positive beta item and/or automatically adding the smallest negative beta candidate to the class and removing the highest beta item from the class to create an updated class.

16. The system of claim 15, further comprising:
generating, using the at least one processor, a beta matrix comprising the plurality of candidates and the respective beta values for each of the plurality of candidates, and the plurality of items and the respective beta values for each of the plurality of items;
storing, using the at least one processor, the beta matrix in a beta database; and
providing user interaction functionality with the beta database via the display window of the GUI.

17. A non-transitory computer-readable medium storing instructions for determining a beta value of at least one candidate relative to a class, the instructions configured to cause at least one processor to perform a method comprising:
receiving, using at least one processor, historical data for the at least one candidate and historical data for the class;
determining, using the at least one processor, a first set of regression coefficients for the historical data for the at least one candidate, and a second set of regression coefficients for the historical data for the class;
calculating, using the at least one processor, the beta value for the at least one candidate relative to the class based on the first set of regression coefficients and the second sets of regression coefficients;
generating, using the at least one processor, an indication that the beta value for the candidate is one of positive, negative, or zero; and
transmitting to at least one display window of a graphical user interface (GUI) a graphical symbol corresponding to the indication of the beta value for the candidate.

18. The non-transitory computer-readable medium of claim 17, wherein the at least one candidate comprises a plurality of candidates, each candidate of the plurality of candidates including a respective set of regression coefficients; the method further comprising:
calculating, using the at least one processor, a respective beta value for each candidate of the plurality of candidates;
generating, using the at least one processor, a beta matrix comprising the plurality of candidates and the respective beta values for each of the plurality of candidates;
storing, using the at least one processor, the beta matrix in a beta database; and
providing user interaction functionality with the beta database via the display window of the GUI.

19. The non-transitory computer-readable medium of claim 17, wherein the class is comprised of a plurality of items, the method further comprising:
receiving, using the at least one processor, historical data for each of the plurality of items;
determining, using the at least one processor, a third set of regression coefficients for the historical data for each of the plurality of items;
calculating, using the at least one processor, a beta value for each of the items relative to the class based on the third set of regression coefficients and the second sets of regression coefficients; and
transmitting to the at least one display window the beta value for each of the items.

20. The non-transitory computer-readable medium of claim 17, wherein the at least one candidate comprises a plurality of candidates, each candidate of the plurality of candidates including a respective set of regression coefficients and the class is comprised of a plurality of items; the method further comprising:
calculating, using the at least one processor, a respective beta value for each candidate of the plurality of candidates;
determining, by the at least one processor, a smallest negative beta candidate from among the plurality of candidates;
receiving, using the at least one processor, historical data for each of the plurality of items;
determining, using the at least one processor, a third set of regression coefficients for the historical data for each of the plurality of items;
calculating, using the at least one processor, a beta value for each of the items relative to the class based on the third set of regression coefficients and the second sets of regression coefficients;
determining, by the at least one processor, a highest positive beta item from among the plurality of items; and
transmitting to the at least one display window the smallest beta candidate and the highest positive beta item and/or automatically adding the smallest negative beta candidate to the class and removing the highest beta item from the class to create an updated class.
